(19) United States
(12) Patent Application Publication
(10) Pub. No.: US 2005/0243485 A1
(43) Pub. Date: Nov. 3, 2005

(54) Leakage current detection interrupter with open neutral detection

(76) Inventors: Bernard J. Gershen, Centerport, NY (US); Steve Campolo, Malverne, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/107,754

(22) Filed: Apr. 18, 2005

Related U.S. Application Data
(60) Provisional application No. 60/565,394, filed on Apr. 26, 2004.

(51) Int. Cl. H02H 3/00

(52) U.S. Cl. 361/42

(57) ABSTRACT

A leakage current detection interrupter (LCDI) having open neutral detection. In one embodiment, the LCDI is formed in a plug and includes a circuit interrupter means for breaking a conductive path between line side phase and neutral conductors and load side phase and neutral conductors. A tripping means is coupled to operate the circuit interrupter means to break the conductive path upon the detection of the opening of the line side neutral conductor referred to as open neutral condition. The tripping means, which uses the neutral path as a return path if leakage current is detected, will, with this invention, use a line side ground conductor as a return path if the neutral path is broken anywhere between a service panel entrance and the plug. In response to the opening of the line side neutral conductor or leakage current, the LCDI interrupts the flow of current to a load such as a window air conditioner.

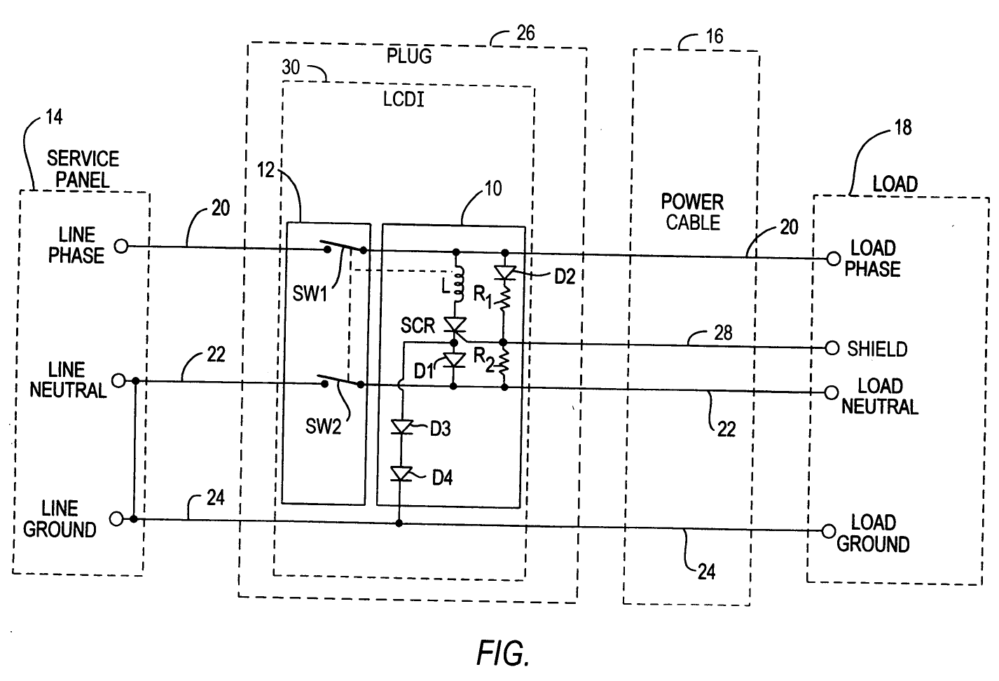

This application claims the benefit of the filing date of a provisional application having Ser. No. 60/565,394 which was filed on Apr. 26, 2004.

### BACKGROUND OF THE INVENTION

1. Field of the Invention

The invention is directed generally to a leakage current detection interrupter (LCDI) with open neutral detection.

2. Description of the Prior Art

The electrical extension cord in use today includes a plug, usually comprising two or three prongs, an electrical conducting cord typically comprising two or three insulated wires several feet in length and a terminal connector or receptacle for receiving one or more electrical plugs to power lamps, a television, household appliances, an air conditioner, etc. A grounded extension cord includes a plug having three prongs and a three conductor insulated wire cord where two conductors are utilized for phase and neutral or return power and the third conductor is used as a common ground. While extension cords provide many advantages, there are some disadvantages that are also associated with their use. For example, extension cords are often left underneath rugs where they are trampled upon, or they are pinched by doors and furniture which can lead to arcing or short circuiting which can cause a fire. Extension cords also frequently tend to be left coiled where heat can concentrate, or are overloaded to the point of destruction by fire. Given the number of dangerous situations which can develop pursuant to extension cord use and abuse, such as residential fires and electrical shock, an extension cord design which offers some protection in anticipation of homeowner/user abuse is desired.

U.S. Pat. No. 5,642,248 assigned to Leviton Manufacturing Co., Inc. of Little Neck, N.Y. discloses an electrical extension cord where the insulated phase, neutral and ground conductors are surrounded by a braided sensing shield. The braided shield is electrically connected at the receptacle to the ground conductor which extends to the plug. Leakage current released from the conductors may be collected in the shield and detected by a ground fault circuit interrupter (GFCI). The purpose of the shield is to capture any type of leakage current within the extension cord and transfer it to ground such that the GFCI may detect the current imbalance and interrupt the circuit. This type of device is commonly known as a leakage current detection interrupter (LCDI).

However, present day GFCI based leakage current detectors may exhibit various problems. For example, one problem that can occur is when a device is plugged into an outlet in such a way that electricity is supplied to the phase terminal but not to the neutral terminal. When this happens the interrupting device is not powered and therefore can not operate because there is no return or neutral circuit. But, high voltage is still available to the user and, therefore, a potentially dangerous situation can exist. Relays that are non-latchable and normally open contact are typically used to prevent high voltage being available to the user when this type of open neutral condition exists. The normally open relay will not close the contacts unless a return circuit is available, and will open if the neutral circuit should open. However, this type of relay is relatively large and consumes a large amount of power. Therefore, what is needed is LCDI circuitry with open neutral detection but with minimal circuitry and low power consumption.

### SUMMARY OF THE INVENTION

The present invention helps overcome some of the above problems by providing a new and improved leakage current detection interrupter (LCDI) with open neutral condition achieved with minimal circuitry and low power consumption. In one embodiment, the LCDI is located in a plug of an extension cord for connection between a source of power such as a service panel and a load such as a window air conditioner. The LCDI includes a circuit interrupter means for breaking a conductive path between line side phase and neutral conductors and load side phase and neutral conductors. A tripping means is coupled to operate the circuit interrupter means to break the conductive path upon detecting the opening of the line side neutral conductor referred to as open neutral condition. The tripping means, which uses the neutral path as a return path if leakage is detected, will, with this invention, use a line side ground conductor as a return path if the neutral path is broken anywhere between the service panel entrance and the plug. In response to the open neutral condition, the LCDI interrupts the flow of current to a load such as a window air conditioner thereby preventing a shock hazard. The LCDI detects an open neutral condition with minimal circuitry and power consumption so that it can be fitted into an electrical plug. For example, the circuit interrupter means includes a pair of normally closed switches connected between the line and load side phase and neutral conductors, respectively, for disconnecting the line side conductors from the load side conductors. The normally closed switches are part of a normally closed relay which is relatively small and consumes small amounts of power compared to a normally open relay arrangement.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features and advantages of the present invention will become more fully apparent from the following detailed description, the appended claim, and the accompanying drawing in which similar elements are given similar reference numerals:

The FIGURE is a schematic of an LCDI circuit for detecting an open neutral detection according to an embodiment of the present invention.

### DETAILED DESCRIPTION OF THE INVENTION

The present invention provides a new and improved leakage current detection interrupter (LCDI) with open neutral condition achieved with minimal circuitry and low power consumption. In one embodiment, the LCDI is located in a plug of an extension cord for connection between a source of power such as a service panel and a load such as a window air conditioner. The LCDI includes a circuit interrupter means for providing a conductive path between line side phase and neutral conductors and load side phase and neutral conductors. A tripping means is coupled to operate the circuit interrupter means to break the conductive path upon detecting the opening of the line side neutral conductor referred to as open neutral condition. The tripping means, which uses the neutral path as a return path if leakage is detected, will, with this invention, use a line side ground conductor as a return path if the neutral path is broken anywhere between the service panel entrance and the plug. In response to the opening of the line side neutral conductor, the LCDI interrupts the flow of current to a load such as a window air conditioner thereby reducing a shock hazard. The LCDI provides open neutral detection with minimal circuitry and power consumption so that it can be fitted into an electrical plug.

In one embodiment, the FIGURE shows a schematic diagram of an extension cord comprising a cable 16 with a receptacle (not shown) for connection to a load 18 and a plug 26 for connection to a source of power such as a service panel 14. The plug 26 holds a LCDI circuit 30 comprising a tripping means 10 for detecting an open neutral condition and a leakage condition and a circuit interrupter means 12 for tripping the LCDI in response thereto. The LCDI circuit 30 is shown connected between the service panel 14 and load 18 via line and load side conductors comprising a phase conductor 20, neutral conductor 22 and ground conductor 24. The LCDI circuit 30 can detect an open neutral condition which occurs when the neutral conductor 22 is broken anywhere between service entrance panel 14 and the plug 26. The tripping means 10 is connected to the ground conductor 24 and across the load side phase and neutral conductors 20, 22 of the power cord 16. The tripping means 10 includes a solid state switching control circuit having a voltage divider formed by diode D2 and resistors R1 and R2 to provide a gate voltage threshold that is below the trigger voltage of the gate of a silicon controlled rectifier (SCR) such that it can detect an open neutral condition as described below in detail. The cathode terminal of the SCR is connected to the load side neutral conductor 22 through diode D1. The cathode terminal is also connected to the ground conductor 24 via a pair of diodes D3, D4. An energizing relay coil (solenoid) L1 is connected between the load side phase conductor 20 and the anode terminal of the SCR.

A conductive shield 28 for carrying leakage current is connected between the gate terminal of the SCR and the load 18. The conductive shield 28 surrounds the conductors 20, 22 and 24 of the cable 16 as part of an extension cord. The term conductive shield refers to a shield which surrounds the various conductors in the extension cord, or one or more wires in substantially parallel relationship with the other wires in the cord, or one or more wires which surround the various wires in an extension cord or the equivalent. It is to be noted that the positioning of the shield relative to the conductors within a flat power cord can take various configurations which allows the circuit to be used to detect leakage current from the line wires of the power cord to the conductive shield. As explained below in further detail, the occurrence of leakage current from any one of the conductors within the shield 28 will be detected by the shield which, through the action of the tripping means 10 and interrupter means 12, operates to interrupt the flow of current through the plug 26 to the extension cord.

The circuit interrupter means 12 comprises an electrical circuit for interrupting the flow of current and includes a first switch SW1 connected in-line with the phase conductor 20 and a second switch SW2 connected in-line with the neutral conductor 22. Switches SW1, SW2 are mechanically latched closed but are also responsive to the flow of current through the energizing coil L and are closed when such current is not flowing. In response to the flow of such current, the coil activates switches SW1, SW2 from the normally closed position to the open position. When current flows through the energizing coil L its magnetic field moves a plunger (not shown) which unlatches switches SW1, SW2. The switches SW1, SW2 and the coil L1 comprise a normally closed relay arrangement which is relatively small and consumes small amounts of power compared to a normally open relay arrangement.

In an open neutral condition, such as when the neutral conductor 22 is broken at the line side, resistor R2 of the voltage divider appears as an open circuit. In response thereto, the SCR conducts through the solenoid coil L1, the diodes D3, D4 to the ground conductor 24. The SCR switches from the normally non-conducting state to the conducting state, thereby providing a path for current to flow through energizing coil L causing switches SW1, SW2 to switch from the normally closed position to the open position. As a result, the LCDI circuit 30 operatively disconnects the phase and neutral conductors (AC source) from the load 18 such as a window air-conditioner or other electrical device.

During normal operation, that is if leakage current is detected via the shield conductor 28 and the neutral conductor 22 is not open or broken, diodes D3, D4 present a two diode voltage drop relative to the ground conductor 24. This voltage drop prevents current from flowing to the ground conductor 24. Instead, current flows through the SCR, to diode D1 and the neutral conductor 22. As in the open neutral condition, the SCR switches from the normally non-conducting state to the conducting state, thereby energizing relay coil L and causing switches SW1, SW2 to switch from the normally closed position to the open position. As a result, the LCDI circuit 30 operatively disconnects the phase and neutral conductors (AC source) from the load 18.

Thus, in response to an open neutral condition, the present invention uses the ground conductor 24 as the return path for energizing coil L causing power to be disconnected to a load such as an air-conditioner. As a result, the open neutral condition is removed, preventing a user from exposure to a shock hazard. In addition, the present invention is capable of detecting a leakage current using a shield conductor, removing power from the load thereby preventing the occurrence of a fire. Therefore, the LCDI of the present invention is able to provide leakage current detection and open neutral detection with minimal circuitry and power consumption so that it can be fitted into an electrical plug which can be part of an extension cord.

The embodiment described in the present invention is directed to a LCDI circuit as part of a three wire conductor (20, 22 and 24) extension cord having a three electrical conductor cable 16 disposed between an AC source compatible plug 26 at the source or line end and a receptacle at the load end. However, it should be understood that the principals of the present invention are applicable to other applications. Exemplary values for the circuit of the present invention are as follows: R1 is 620,000 ohms, R2 is 5100 ohms, D1-D4 is IN4004 and the SCR is 2N5064.

While there have been shown and described and pointed out the fundamental novel features of the invention as applied to the preferred embodiments, it will be understood that various omissions and substitutions and changes of the form and details of the method and apparatus illustrated and in the operation may be done by those skilled in the art, without departing from the spirit of the invention.

1. A leakage current detection interrupter (LCDI) comprising:
a circuit interrupter means for breaking a conductive path between line side phase and neutral conductors and load side phase and neutral conductors; and
a tripping means coupled to the circuit interrupter means to break the conductive path in response to detecting an opening of the line side neutral conductor using a line side ground conductor as a return path.

2. The leakage current detection interrupter of claim 1 where the tripping means includes one or more diodes serially connected between an output of the tripping means and the ground conductor.

3. The leakage current detection interrupter of claim 1 where the tripping means includes a voltage divider circuit connected across the load side phase and neutral conductors with a voltage threshold to detect the opening of the line side neutral conductor.

4. The leakage current detection interrupter of claim 1 where the leakage detection interrupter is formed in an electrical wiring plug as part of an extension cord.

5. The leakage current detection interrupter of claim 1 where the tripping means includes a semiconductor controlled switch connected across the load side phase and neutral conductors where the switch conducts upon the opening of line side neutral conductor.

6. The leakage current detection interrupter of claim 1 where the circuit interrupter means includes a first normally closed switch connected between the line and load side phase conductors, and a second normally closed switch connected between the line and load side neutral conductors, where the tripping means causes the first and second switches to switch to an open position the opening of the line side neutral conductor, thereby disconnecting the line side conductors from the load side conductors.

7. The leakage current detection interrupter of claim 6 where the circuit interrupter means includes a solenoid coil to cause the first and second switches to switch an open position upon the opening of the line side neutral conductor.

8. The leakage current detection interrupter of claim 1 further comprising a shield conductor for connection between the tripping means and a load where the shield conductor conducts leakage current between the line and neutral conductors and the shield conductor.

9. An electrical extension cord comprising:
an electrical cable including separate, insulated phase, neutral and ground conductors;
an electrical plug connected to a line side of the phase and neutral conductors and to a ground conductor;
a circuit interrupter means electrically connected to the line side phase and neutral conductors, and load side phase and neutral conductors; and
a tripping means coupled to operate the circuit interrupter means to electrically disconnect the line side phase conductor from the load side phase conductor upon detecting the opening of line side neutral conductor where the tripping means uses the ground conductor as a return path.

10. The cord of claim 9 where the tripping means includes one or more diodes serially connected between an output of the tripping means and the ground conductor.

11. The cord of claim 9 where the tripping means includes a voltage divider circuit connected across the load side phase and neutral conductors with a voltage threshold to detect the opening of the line side neutral conductor.

12. The cord of claim 9 where the leakage detection interrupter is formed in an electrical wiring plug as part of an extension cord.

13. The cord of claim 9 where the tripping means includes a semiconductor controlled switch connected across the load side phase and neutral conductors where the switch conducts upon the opening of line side neutral conductor.

14. The cord of claim 9 where the circuit interrupter means includes a first normally closed switch connected between the line and load side phase conductors, and a second normally closed switch connected between the line and load side neutral conductors, where the tripping means causes the first and second switches switch to an open position upon the opening of the line side neutral conductor, thereby disconnecting the line side conductors from the load side conductors.

15. The cord of claim 14 where the circuit interrupter means includes a solenoid coil to cause the first and second switches to switch to an open position upon the opening of the line side neutral conductor.

16. The cord of claim 9 further comprising a shield conductor for connection between the tripping means and a load where the shield conductor conducts leakage current between the line and neutral conductors and the shield conductor.
